(19) United States
(12) Patent Application Publication
(10) Pub. No.: US 2015/0134740 A1
(43) Pub. Date: May 14, 2015

(54) DREAM ORIENTED SOCIAL MEDIA WEBSITE

(71) Applicants: Kenneth Scott FORSTER, Prescott, AZ (US); Timothy Don WHITE, Tempe, AZ (US)

(72) Inventors: Kenneth Scott FORSTER, Prescott, AZ (US); Timothy Don WHITE, Tempe, AZ (US)

(21) Appl. No.: 14/311,865

(22) Filed: Jun. 23, 2014

Related U.S. Application Data
(60) Provisional application No. 61/838,127, filed on Jun. 21, 2013.

(51) Int. Cl. H04L 29/08

(52) U.S. Cl. CPC H04L 67/306; H04L 67/22
USPC 709/204

(57) ABSTRACT

A method and system for sharing dream narratives. The system comprises a computer network comprising a plurality of user interfaces, and each user interface has a display and an input module for inputting dream narratives from a plurality of users. A computer processor connected to the computer network, and the computer processor comprises instructions to create user profiles for each of the plurality of users; receive dream narratives over the computer network and record the dream narratives in association with a respective user profile; analyze the dream narratives to develop dream profiles by identifying keywords and phrases; compare the dream profiles to identify commonalities between the dream profiles; and connect user profiles having at least one commonality in their respective dream narratives.

### TECHNICAL FIELD

This relates to social media websites and in particular, a website for comparing dreams with other dreamers, connecting dreamers with those that have similar dreams, and compiling dreams for analysis.

### BACKGROUND

Dreams are a poorly understood psychological phenomenon, which may provide an avenue for discovery into the unconscious. Dreams are believed by some to provide the basis for personal insights and growth. Some dreams include common elements, and different people may have the same or similar dreams.

Social media websites provide an avenue for making and maintaining connections with people throughout the world.

### SUMMARY

There is provided a system for sharing dream narratives. The system has a computer network comprising a plurality of user interfaces. Each user interface having a display and an input module for inputting dream narratives from a plurality of users. A computer processor is connected to the computer network. The computer processor comprises instructions to create user profiles for each of the plurality of users; receive dream narratives over the computer network and record the dream narratives in association with a respective user profile; analyze the dream narratives to develop dream profiles by identifying keywords and phrases; compare the dream profiles to identity commonalities between the dream profiles; and connect user profiles having at least one commonality in their respective dream narratives.

In some aspects, the instructions connect user profiles comprises displaying a connection request on the display of one or more user interfaces associated with the user profiles to be connected.

In some aspects, the computer processor further comprises instructions to generate a comparison score based on the number of commonalities between dream profiles. The computer processor may further comprise instructions to display the comparison scores on a map, and permit the user initiating a connection with another user by selecting a comparison score. The computer processor may further comprise instructions to permit a user to record a single dream narrative in a day.

In some aspects, the computer processor further comprises instructions to permit a user to delete a previously inputted dream narrative and to prevent a user from modifying the previously inputted dream narrative.

In some aspects, the user profiles comprise geographic and demographic information of the users. The computer processor may further comprise instructions to generate a searchable database comprising information from the dream profiles and the user profiles. The dream profiles may further comprise themes and sequences identified from the dream narratives. The computer processor may further comprise instructions to make predictions and extrapolations based on the database.

According to another aspect, there is provided a method of sharing dream narratives, The method comprises providing a computer network that connects between a computer processor and a plurality of user interfaces, each user interface having a display and an input module; creating user profiles for each of the plurality of users in the computer processor; causing the computer processor to record dream narratives that are input into the input module by a user, the dream narratives being associated with a respective user profile; using the computer processor, analyzing the dream narratives to develop dream profiles by identifying keywords and phrases; comparing the dream profiles to identify commonalities between the dream profiles; and connecting user profiles having at least one commonality in their respective dream narratives.

In some aspects, connecting user profiles comprises displaying a connection request on the display of one or more user interfaces associated with the user profiles to be connected.

In some aspects, the method further comprises the step of generating a comparison score based on the number of commonalities between dream profiles. The comparison scores may be displayed on a map, and users may be permitted to initiate a connection with another user by selecting a comparison score.

In some aspects, users are permitted to record a single dream narrative in a day.

In some aspects, users are permitted to delete a previously inputted dream narrative and to prevent a user from modifying the previously inputted dream narrative.

In some aspects, the user profiles comprise geographic and demographic information of the users. A searchable database may be generated that comprises information from the dream profiles and the user profiles. The dream profiles may further comprise themes and sequences identified from the dream sequences. The computer processor may further comprise instructions to make predictions and extrapolations based on the database.

The aspects described above may be combined in any logical connection except where prohibited by mutually exclusive combinations.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 illustrates a computer system according to an exemplary embodiment.

FIG. 2 is a diagram illustrating an exemplary embodiment of a cloud-based data storage and processing system.

FIG. 3 is a screenshot of a home page for a website entitled DreamCloud.

FIG. 4 is a screenshot of a login page for the website.

FIG. 5 is a screenshot of a user profile for the website.

FIG. 6 is a screenshot of a dream comparison page for the website.

FIGS. 7 through 9 are screenshot of a dream comparison page for the website.

FIG. 10 is a screenshot of a connection page connecting users with similar dreams

FIG. 11 is a screenshot of a page with a dream narrative.

FIG. 12 is a screenshot of a search page for searching for information in dream narratives.

FIG. 13 is a screenshot of a narrative for “DreamCloud the Movie”

FIG. 14 is a screenshot of a page displaying historic dreams.

FIGS. 15 through 20 are screenshots of stories of historic dreams.

### DETAILED DESCRIPTION

This relates to a website on which people may register and record their dreams on a regular, such as daily, basis. Commonality between dreams may be recognized by the computer system, and information regarding users dreams may be provided to other users, depending on the content of their dream. A venues for communication between different users having similar dreams may be provided.

Relationships between dreams may be recognized by a computer algorithm that identifies common words, accounting for various spellings or misspellings and words with related meanings, common themes, and common phrases. A machine translation component may translate all inputted dreams into a common language prior to performing commonality testing.

Trust scores may be provided by the system to users based on other user ratings and/or feedback. Trust scores may provide a basis for filtering other users having similar dreams for possible contact. Contact between users may be provided on an anonymous basis, at the authorization of one or both users, and may be provided by an internal messaging system.

Dreams of a single user or multiple users may be chained together by a system running the present technology based on keyword correspondences or logical connections between subject matter and/or themes addressed in the dreams.

A mobile application may be provided that enables a user to access the system from a mobile device. The mobile application may also include a voice-to-text functionality to enable a user to input a narrative description of a dream by speaking into the mobile device. The mobile application may assist in uploading a dream to one's smart phone, thereby giving immediate access to inputting a dream before it disappears from the user's consciousness. In this manner, a quick and easy input method is provided that enables a user to input a dream upon waking without leaving bed or even opening the eyes.

A dream-based social media website is provided that includes a user interface. The social media website may limit a user to one dream input per day. The limit of one dream per day is intended to prevent misuse of the technology, such as by unscrupulous users flooding the system.

The social media website may prevent editing of a dream narrative after input. The dream narrative may be entered and time-stamped, and the system may not allow editing in order to prevent misuse by users gaming the system to promote contacts with other users that are not truly based on common dreams. A user may be provided with the opportunity to delete a dream in order to promote trust in the system and forthright dream narratives.

The system may enable a user to delete a dream and/or make it private. Additionally, the social media website may prompt a user to input a dream narrative after waking, and enable a user to input that they did not dream, and/or did not remember their dream on a given night. A check box may be provided by the social media website that the dreamer did not have a dream on a specific date, and this information may assist in determining how often an individual person dreams, for their own interest or for sociological interests when the information is separated from identifying information. This information may also be used to determine how often people across the world dream.

The social media website may collect data on the dreams input and may present generalized information to all users, or some users if a premium subscription model is used, or basic information to some users and more detailed information to subscribers of the premium service. The generalized information may be presented in a database and may include significant words or themes present in users' dream descriptions for a given night, week, month or year, or any other appropriate time-frame. The database may also include demographic information related to the user. The processor for the website may analyze the database to generate trends or predictions based on the data or to extrapolate the data extracted from dreams. The website may prompt users viewing the data to either connect with others having particular dreams of interest, or to gather users having particular dream characteristics into a group. Users may also use the data to find their own trends and related users.

Product marketing and/or research may be assisted by a chat room that enables users having similar dreams that involve business or product development to join forces to develop their ideas. The think tank provided by the social media website may enable collaboration between users having similar dreams and interests. An opportunity to protect intellectual property before, during or after a chat room session may be provided by enabling a link to an external professional and/or by providing instructions or guidance for obtaining intellectual property protection.

In one example, the social media website allows a user to compare their dream each day with others around the world. Once a dream is entered a map of the world appears. Assuming there is a match, dots are presented on the map, with a Green dot representing a 90% or greater match in the narrative descriptions of the user and another dreamer, a Yellow dot representing a 70% or greater match, and a Red dot representing a 50% or greater match. Each dot can be hovered over showing the Country, State, and City as well Username of the corresponding dreamer having a matching narrative. Additionally, the dream entered by the corresponding dreamer may be viewed by the user for comparison with their own dream. Secured Communication can be requested by the user with the other dreamer. Each Dreamer is allowed to enter one dream per day, and once entered, the dream narrative cannot be edited or manipulated in any way. All dreams entered by a user are logged onto their user page, as well as time and date stamped to review and/or share over the course of a lifetime. Preferably, dreams cannot be edited, but only deleted by the user. Dreams are not made public and are shared only with other dreamer's if there is a match. General information such as topics and keywords may be made available through the database without sharing individual dreams.

Users have the ability to chain their dreams with other users. The system then runs a program based on specific algorithms to match logical portions of dreams in completing a story, product, or a precursor to a worldwide event. The system intends to give dreamers the ability to explore, if and where their dream ends, whether another user's dream may be provide a middle narrative, and perhaps another user's dream may possibly be the end to a complete dream.

The system may provide third parties, such as the scientific community, researchers, and corporations, information based on a specific query. This allows them be able to see what people are dreaming about based on their input, for example “what women are dreaming about in the age group of 30-38 in northern Europe at a specific moment in time.” Additionally, research may be organized around a key word search, for example “Car Color”. Combining these two examples, researchers may be able to determine the percentages of woman who dreamt what color car they preferred. These queries can be isolated to a street in any part of the world, or as broad as a query and keyword search of the coming of Jesus worldwide.

The application may be a mobile application, and/or may be used on a laptop, smartphone or PDA, and may be downloadable or web-based. Alternatively, the system may be implemented in software and/or hardware.

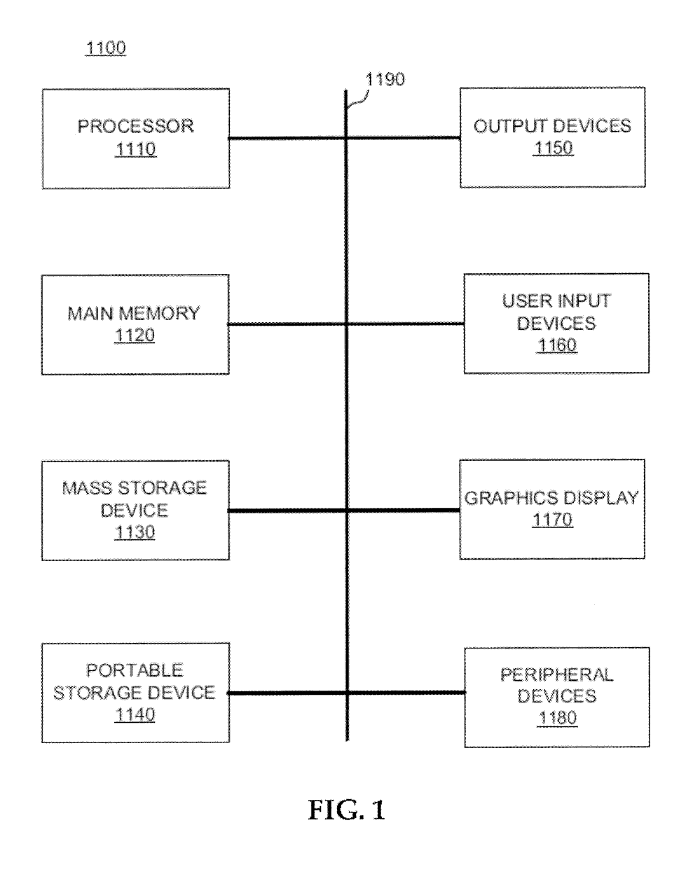

FIG. 1 illustrates an exemplary computing system 1100, hereinafter system 1100, that may be used to implement embodiments of the present invention. The system 1100 may be implemented in the contexts of the likes of computing systems, networks, servers, or combinations thereof. The system 1100 may include one or more processors 1110 and main memory 1120. Main memory 1120 stores, in part, instructions and data for execution by processor 1110. Main memory 1120 may store the executable code when in operation. The system 1100 may further includes a mass storage device 1130, portable storage device(s) 1140, output devices 1150, user input devices 1160, a graphics display 1170, and peripheral device(s) 1180.

The components shown in FIG. 1 are depicted as being connected via a single bus 1190. The components may be connected through one or more data transport means. Processor 1110 and main memory 1120 may be connected via a local microprocessor bus, and the mass storage device 1130, peripheral device(s) 1180, portable storage device 1140, and graphics display 1170 may be connected via one or more input/output (I/O) buses.

Mass storage device 1130, which may be implemented with a magnetic disk drive or an optical disk drive, is a non-volatile storage device for storing data and instructions for use by processor 1110. Mass storage device 1130 may store the system software for implementing embodiments of the present invention for purposes of loading that software into main memory 1120.

Portable storage device 1140 operates in conjunction with a portable non-volatile storage medium, such as a floppy disk, compact disk, digital video disc, or USB storage device, to input and output data and code to and from the system. The system software for implementing embodiments of the present invention may be stored on such a portable medium and input to the system 1100 via the portable storage device 1140.

User input devices 1160 provide a portion of a user interface. User input devices 1160 may include one or more microphones, an alphanumeric keypad, such as a keyboard, for inputting alpha-numeric and other information, or a pointing device, such as a mouse, a trackball, stylus, or cursor direction keys. User input devices 1160 may also include a touchscreen. Additionally, the system 1100 as shown in FIG. 1 includes output devices 1150. Suitable output devices include speakers, printers, network interfaces, and monitors.

Graphics display 1170 may include a liquid crystal display (LCD) or other suitable display device. Graphics display 1170 receives textual and graphical information, and processes the information for output to the display device.

Peripheral devices 1180 may be included and may include any type of computer support device to add additional functionality to the computer system.

The components provided in the system 1100 are those typically found in computer systems that may be suitable for use with embodiments of the present invention and are intended to represent a broad category of such computer components that are well known in the art. Thus, the system 1100 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), Blu-ray Disc. (BD), any other optical storage medium, RAM, PROM, EPROM, EEPROM, FLASH memory, and/or any other memory chip, module, or cartridge.

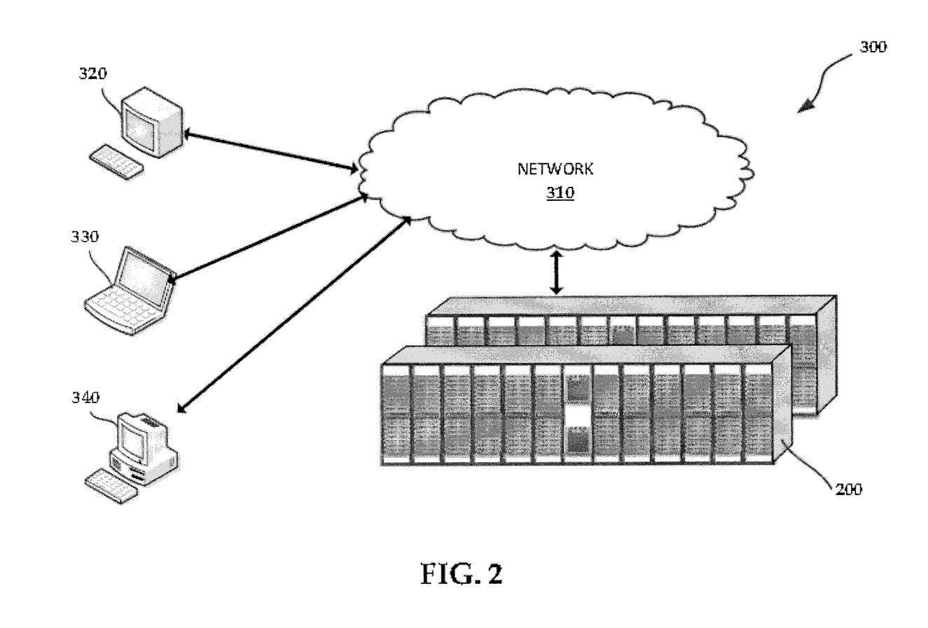

FIG. 2 illustrates cloud-based data storage and processing system 300. Cloud-based data storage and processing system 300 includes datacenter 200 communicatively coupled to network 310. Network 310 may be a wide-area network (WAN), a local area network (LAN), the Internet, or any other appropriate network. Customers may access cloud-based data storage and processing system 300 by using any of customer terminal 320, customer laptop 330 and/or customer personal computer 340 to access network 310.

There will now be described an example of a website entitled “DreamCloud” that implements some of the principles described herein. While this technology is susceptible of embodiment in many different forms, what is shown in the drawings and described below is one embodiment and it will be understood that the present disclosure is to be considered as an exemplification of the principles of the technology and is not intended to limit the technology to the embodiments illustrated.

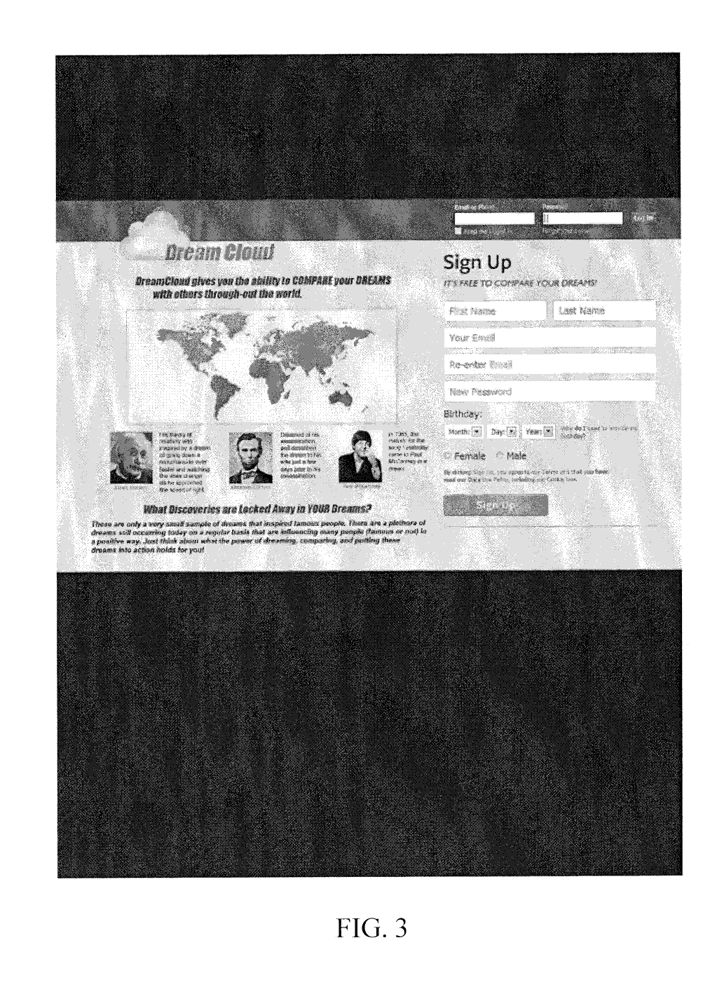

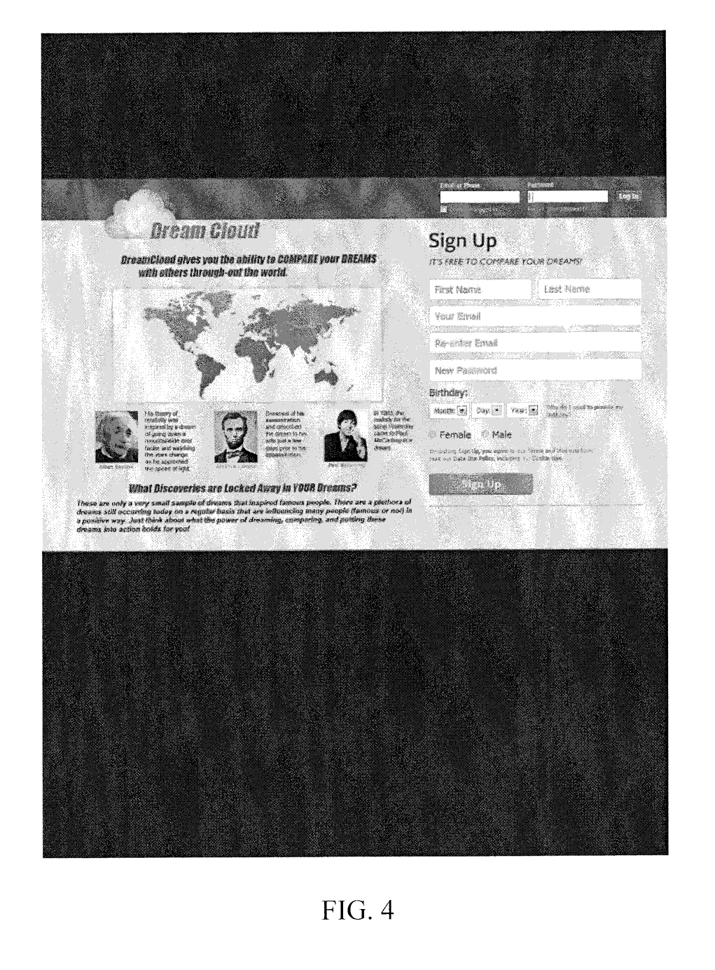

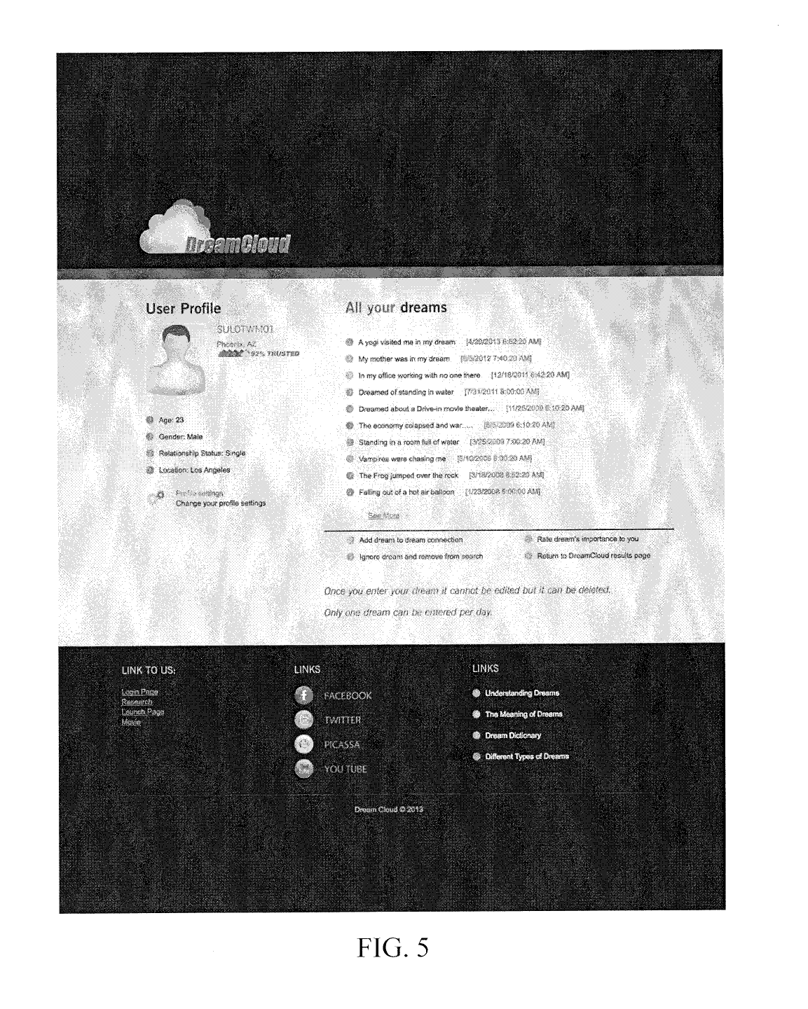

Referring to FIG. 3 a homepage for the DreamCloud website provides a user with links to “DreamCloud the Movie”, “Historic Dreamers” and “DreamCloud Website”. Referring to FIG. 4, selecting “DreamCloud Website” takes a user to a login page, which allows a user to create a new profile by entering the user's birthday and gender. The user's location may be determined by their computer's location, or the user may be prompted to enter the information. Other demographic information may also be collected as desired, such as income level, race, ethnicity, personal background, family, etc. as is known in the art. FIG. 5 is a screenshot of a user's profile page showing their personal information on one side and a list of their dreams on the other. The website preferably allows users to enter one dream per day. The website also allows users to rank their dreams, ignore their dreams, and may allow users to delete dreams, but not edit previously entered dreams. As dreams narratives are recorded, the website analyzes the dreams to identify elements such as keywords, phrases, themes, sequences and the like. The dream narratives may be analyzed using approaches that are well known in searching algorithms and preferably accounts for common spelling variations or errors as well as words with similar meanings. The results are tabulated in a database and are preferably connected with the demographic or location information for each user. In analyzing the dream narratives, it should be noted that the database is not intended to interpret the dream narrative, but rather to tabulate themes and keywords and compare for trends or similarities among other dreams.

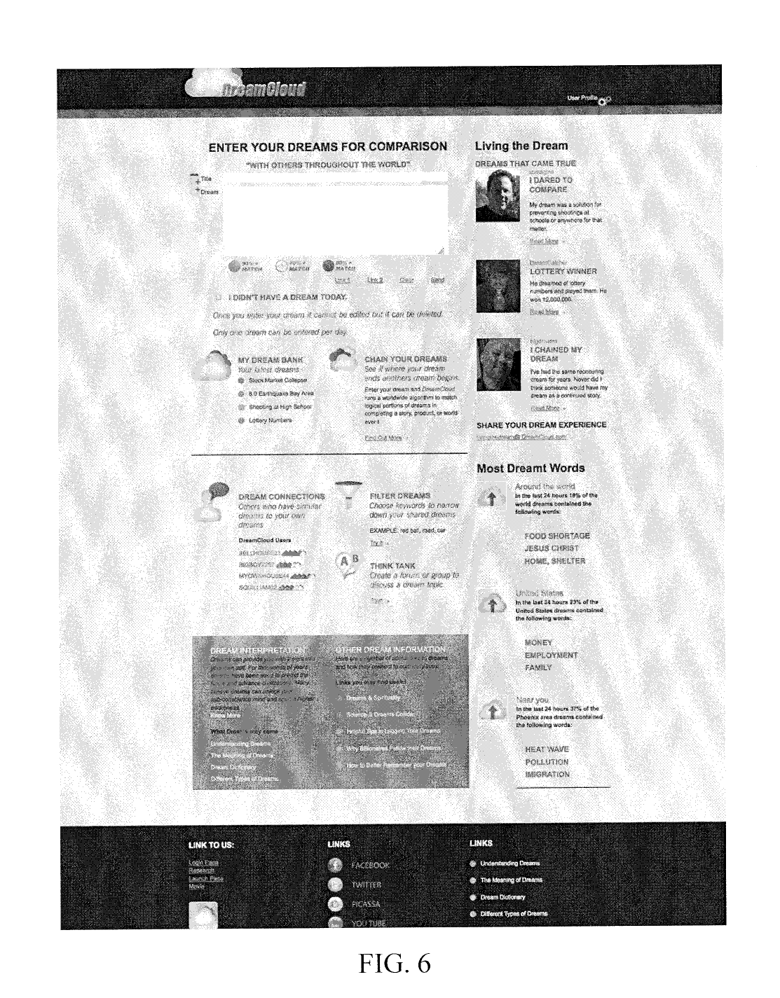

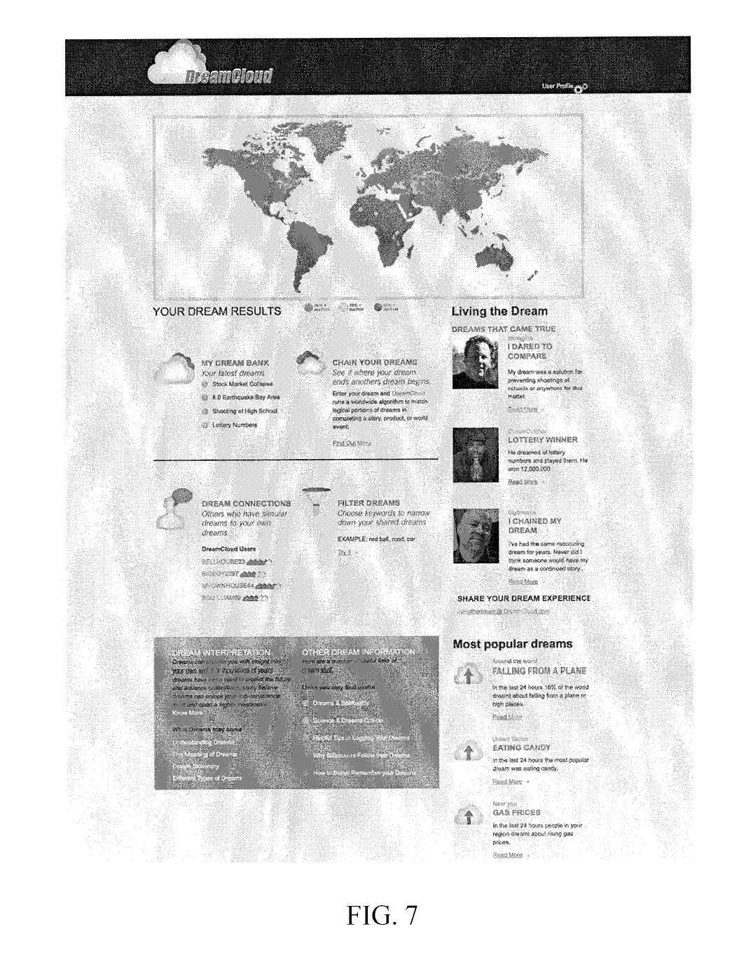

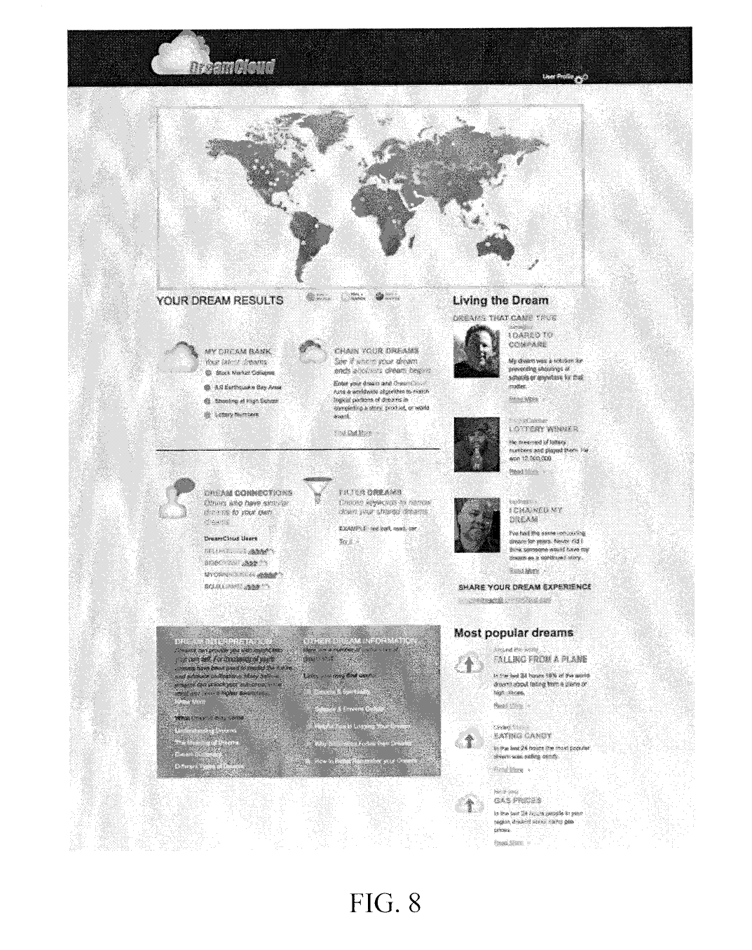

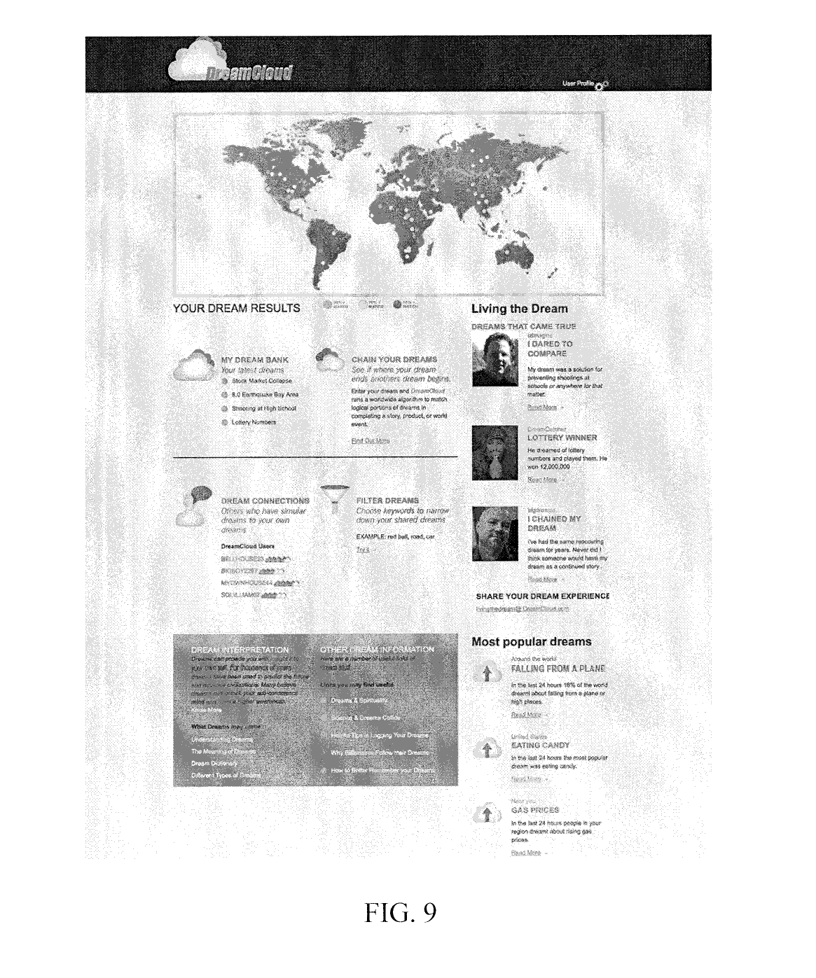

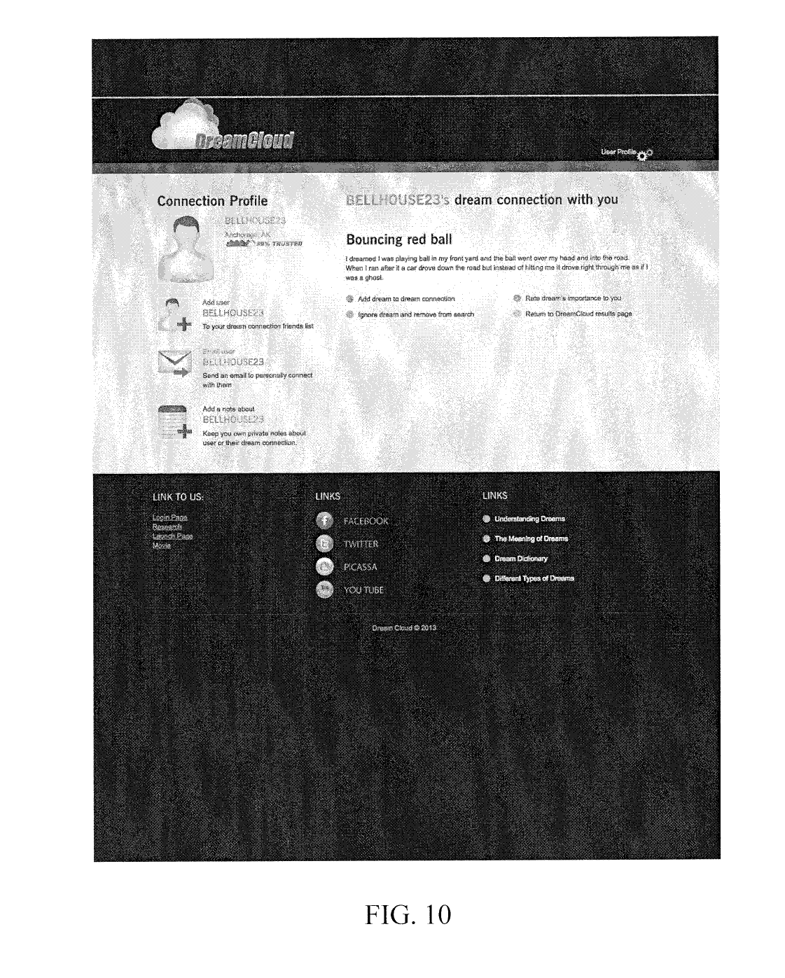

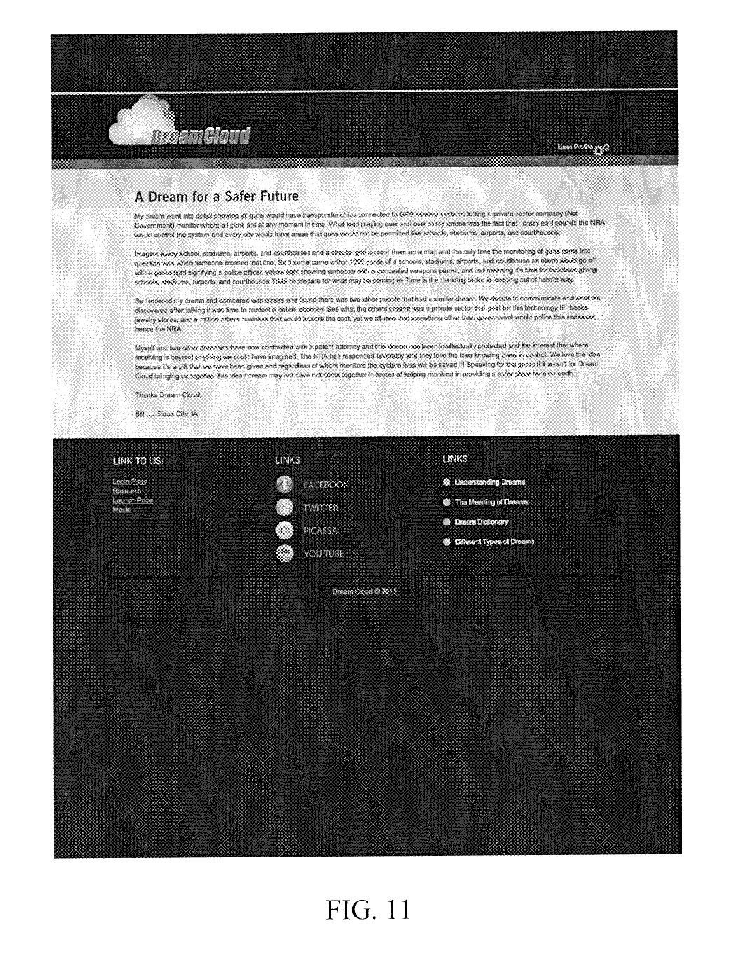

FIGS. 6 through 9 are examples of the results displayed for a user searching for other users with similar dreams. The comparison and search results may be based on a single dream identified by the user, a series of dream narratives that the user may feel are related, a series of dream narratives that the website identifies as being related, or a series of dream narratives in a particular timeframe or time sequence. For example, a user may query whether others had a dream similar to their dream in the last day or two or over the past week or month, or may query whether others have had similar recurring dreams, or may query whether others have had dreams with a particular theme over time. Other queries may also be defined as preferred by the user or the website operator. The search results may be displayed on a map as shown, in a list format or in other ways. Preferably, the website generates a rank based on how well the other user matches the user's query. These rankings may be based on search results algorithms that are well known in the art. Based on the search results and the basic information provided, a user may initiate contact with other users as shown in FIG. 10. Preferably, this is done by sending a request through the website, which results in the other user being prompted by a connection request sent by the website. The connection request may also be initiated by the website and sent to both users, based on similarities that may be detected in analysing the dream narratives and as a suggestion of others who may have compatible dream narratives. Once both users have approved the connection, the website preferably provides a mechanism to allow the users to communicate anonymously. A direct connection may be facilitated if both users consent. Users may also consent to having one or more dreams shared with the other user, depending on the dreams that are found to be related. FIG. 11 is an example of a dream narrative being shared with the other user. As a user may have different dreams that relate to different topics, or dreams that may be considered private, the user may have the option of classifying dreams according to topic or as being public or private. Public dreams may be shared with others users once connections are made with respect to a particular dream or collection of dreams, while private dreams would not be shared. In some embodiments, connections may be made among a plurality of users, allowing them to collaborate or have group discussions together related to their dreams.

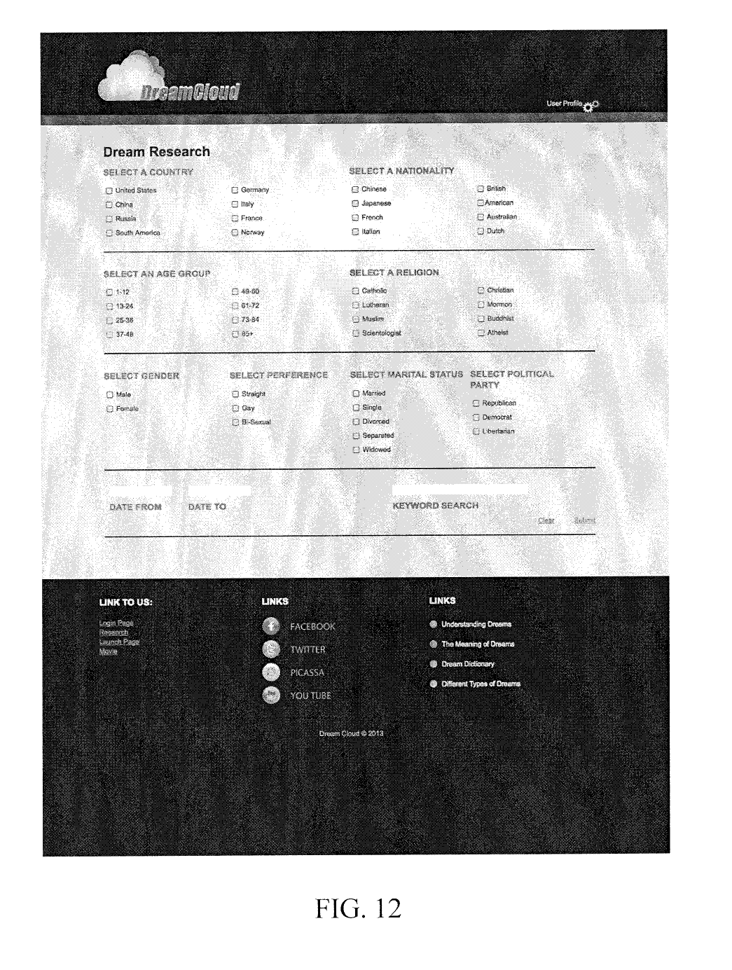

Referring to FIG. 12, there is shown a search page that allows a user to search dreams based on various factors, such as country or location, nationality, religion, marital status, political gender, etc. that will be found in the database. Other search options may also be available. It will be understood that the database may be used to mine data in various ways and may include direct searches, or may involve multivariate statistical methods to identify trends or commonalities among dreams.

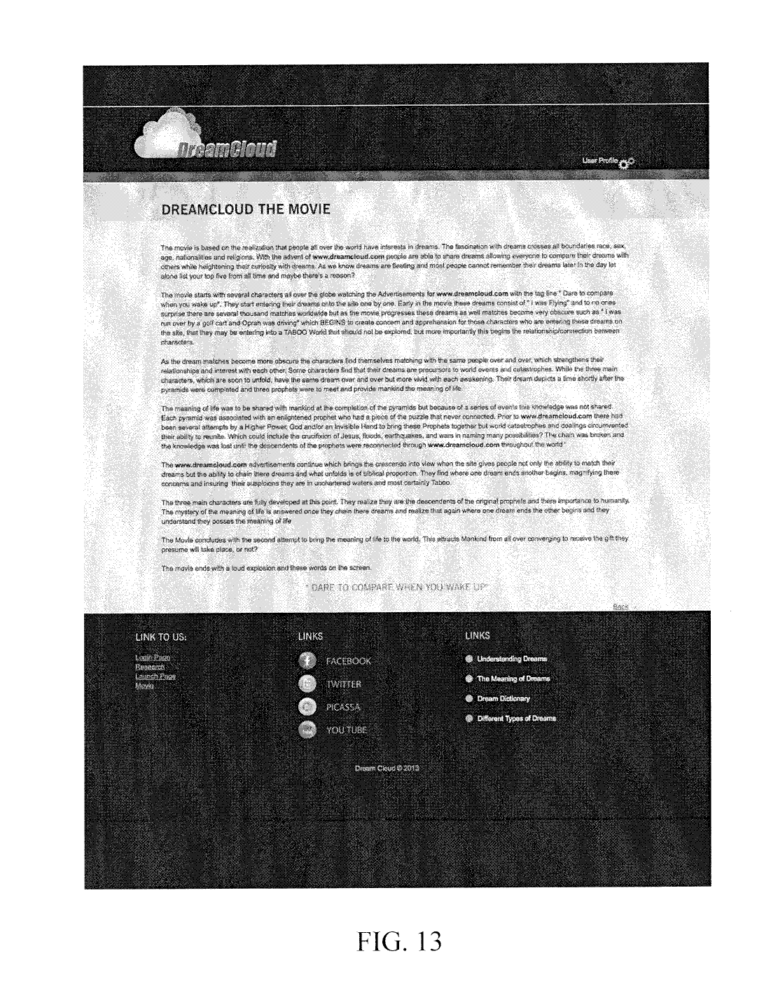

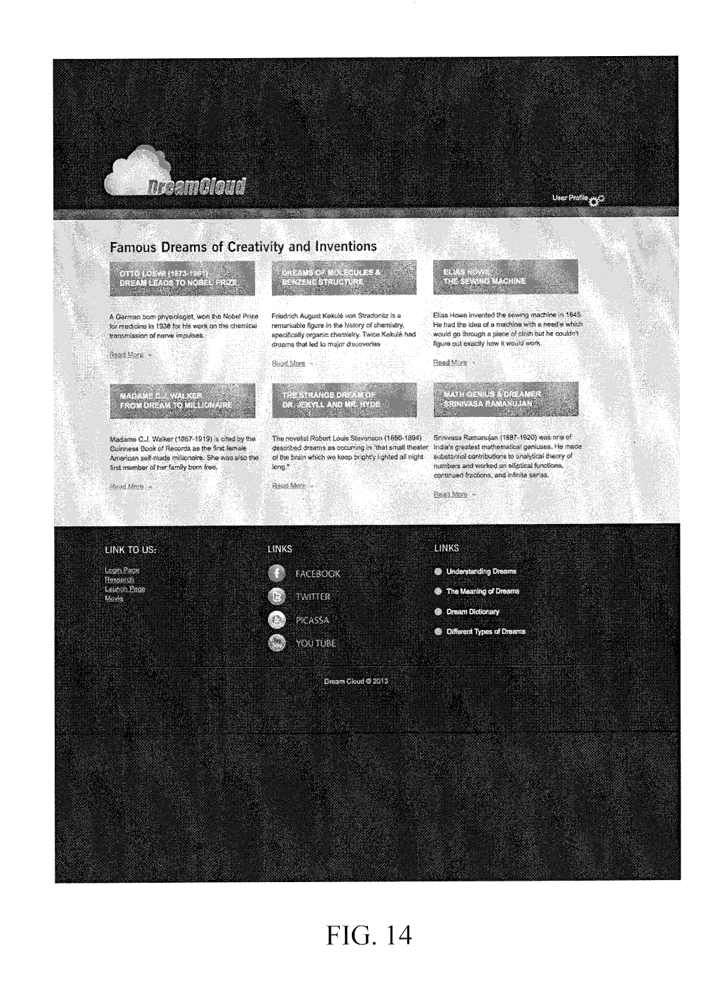

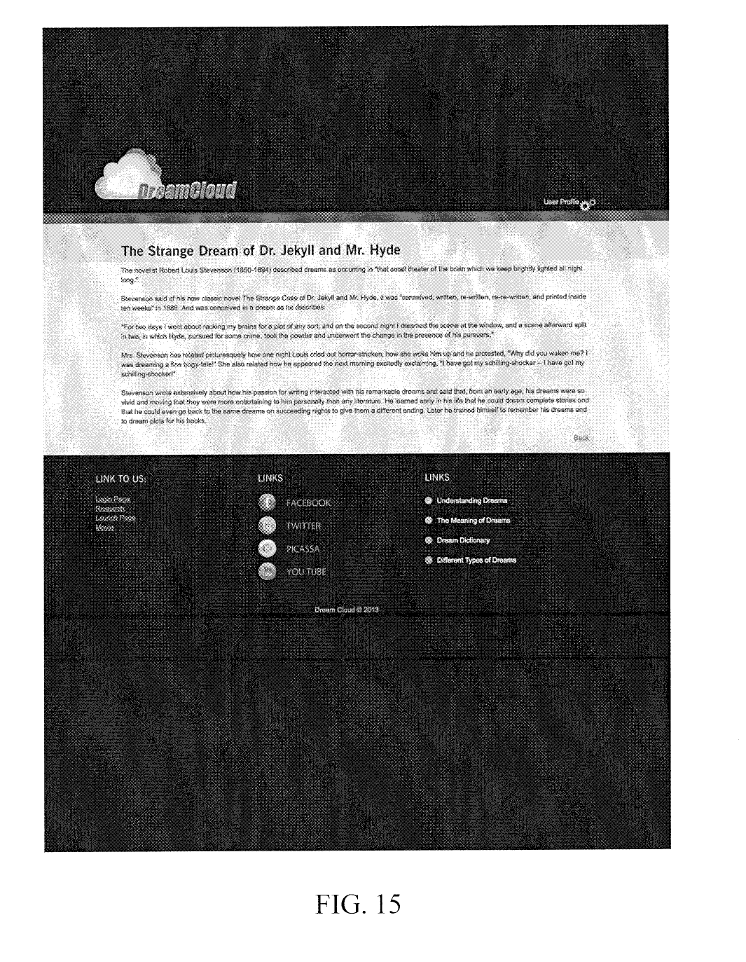

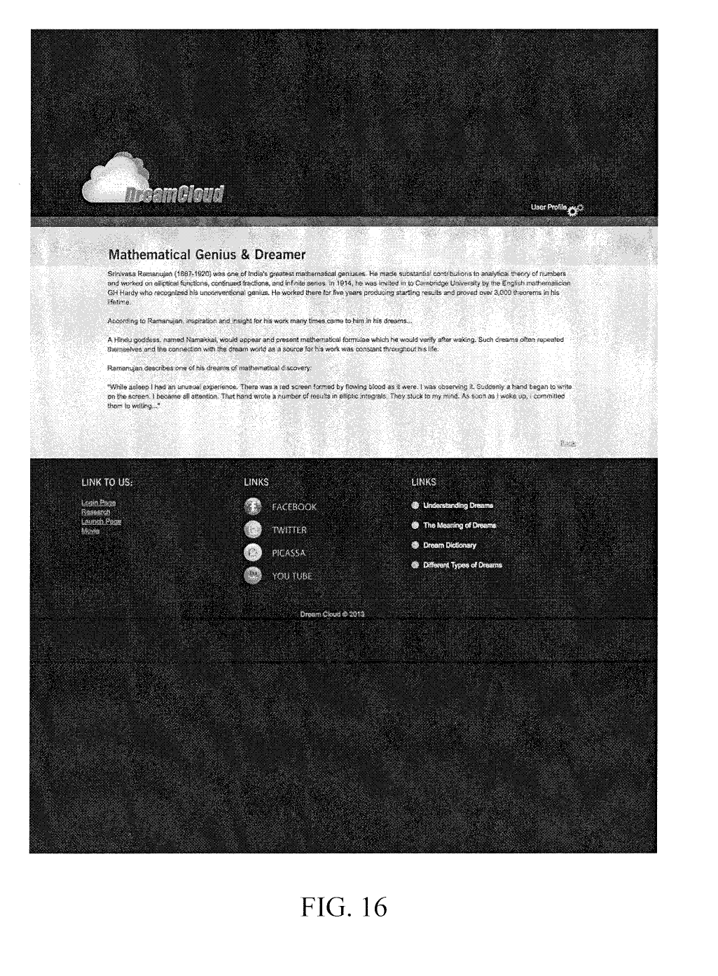

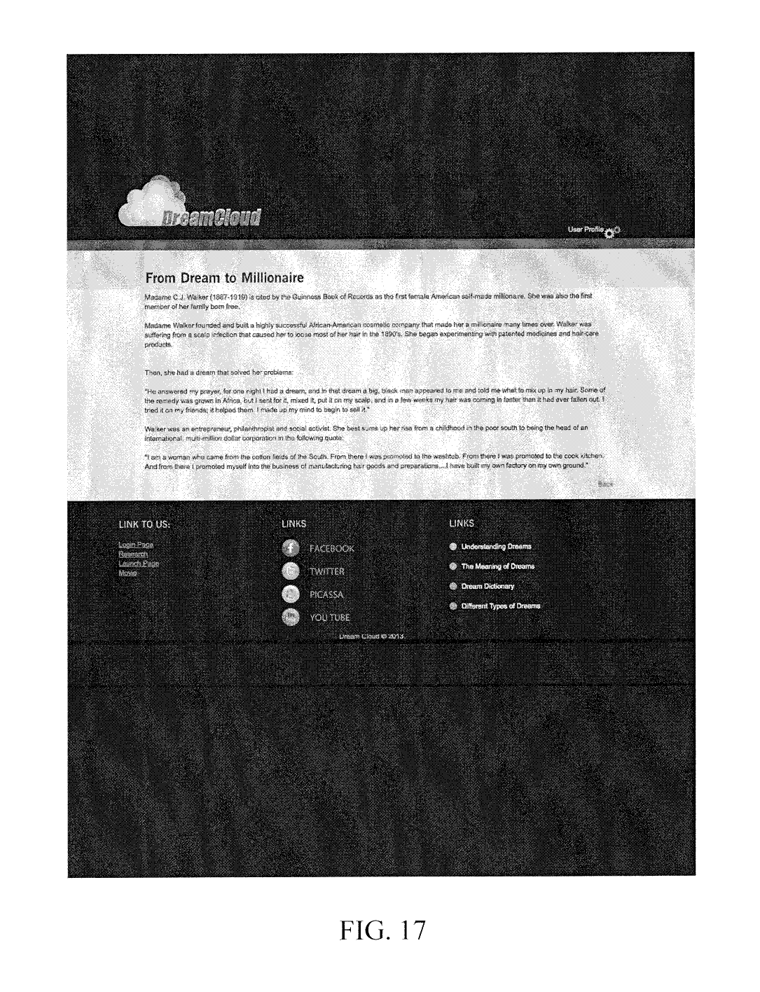

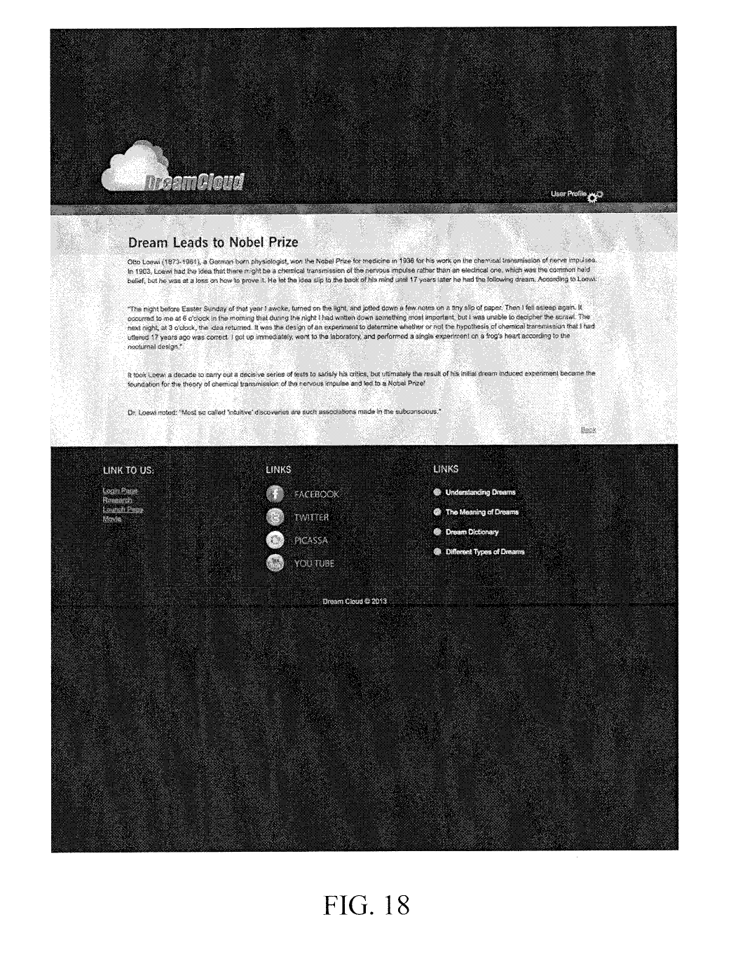

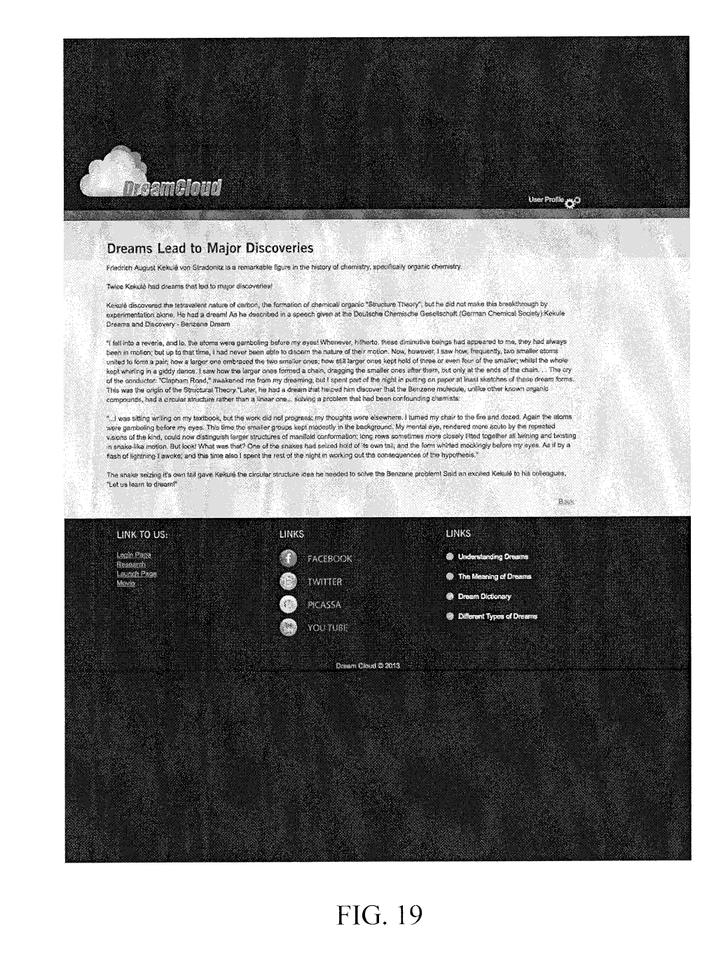

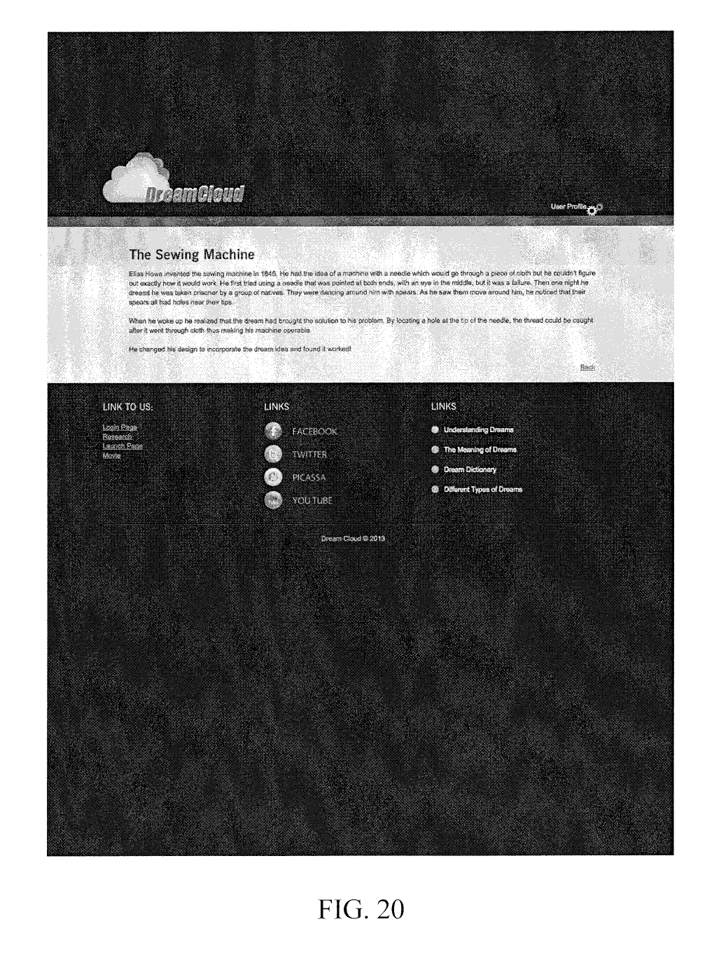

FIG. 13 is a screenshot of an example of what may result from a collaboration between a group of two or more users, such as a movie plot, new product, or other idea that may be developed based on the user's dreams. FIGS. 14 through 20 are example pages of historical dreamers that may be provided for inspiration or to help others understand the importance of dreams.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A system for sharing dream narratives, comprising:
a computer network comprising a plurality of user interfaces, each user interface having a display and an input module for inputting dream narratives from a plurality of users; and
a computer processor connected to the computer network, the computer processor comprising instructions to:
create user profiles for each of the plurality of users;
receive dream narratives over the computer network and record the dream narratives in association with a respective user profile;
analyze the dream narratives to develop dream profiles by identifying keywords and phrases;
compare the dream profiles to identify commonalities between the dream profiles; and
connect user profiles having at least one commonality in their respective dream narratives.

2. The system of claim 1, wherein the instructions to connect user profiles comprise displaying a connection request on the display of one or more user interfaces associated with the user profiles to be connected.

3. The system of claim 1, wherein the computer processor further comprises instructions to generate a comparison score based on the number of commonalities between dream profiles.

4. The system of claim 3, wherein the computer processor further comprises instructions to display the comparison scores on a map, and permit the user initiating a connection with another user by selecting a comparison score.

5. The system of claim 1, wherein the computer processor further comprises instructions to permit a user to record a single dream narrative in a day.

6. The system of claim 1, wherein the computer processor further comprises instructions to permit a user to delete a previously inputted dream narrative and to prevent a user from modifying the previously inputted dream narrative.

7. The system of claim 1, wherein the user profiles comprise geographic and demographic information of the users.

8. The system of claim 7, wherein the computer processor further comprises instructions to generate a searchable database comprising information from the dream profiles and the user profiles.

9. The system of claim 8, wherein the dream profiles further comprise themes and sequences identified from the dream narratives.

10. The system of claim 9, wherein the computer processor further comprises instructions to make predictions and extrapolations based on the database.

11. A method of sharing dream narratives, comprising:
providing a computer network that connects between a computer processor and a plurality of user interfaces, each user interface having a display and an input module;
creating user profiles for each of the plurality of users in the computer processor;
causing the computer processor to record dream narratives that are input into the input module by a user, the dream narratives being associated with a respective user profile;
using the computer processor, analyzing the dream narratives to develop dream profiles by identifying keywords and phrases;
comparing the dream profiles to identify commonalities between the dream profiles; and
connecting user profiles having at least one commonality in their respective dream narratives.

12. The method of claim 11, wherein connecting user profiles comprises displaying a connection request on the display of one or more user interfaces associated with the user profiles to be connected.

13. The method of claim 11, further comprising the step of generating a comparison score based on the number of commonalities between dream profiles.

14. The method of claim 13, further comprising the step of displaying the comparison scores on a map, and permitting the user to initiate a connection with another user by selecting a comparison score.

15. The method of claim 11, wherein the computer processor permits a user to record a single dream narrative in a day.

16. The method of claim 11, wherein the computer processor permits a user to delete a previously inputted dream narrative and prevents a user from modifying the previously inputted dream narrative.

17. The method of claim 11, wherein the user profiles comprise geographic and demographic information of the users.

18. The method of claim 17, further comprising the step of generating a searchable database comprising information from the dream profiles and the user profiles.

19. The method of claim 18, wherein the dream profiles further comprise themes and sequences identified from the dream sequences.

20. The method of claim 19, further comprising the step of making predictions and extrapolations based on the database.
